(19) United States
(12) Patent Application Publication
(10) Pub. No.: US 2020/0324255 A1
(43) Pub. Date: Oct. 15, 2020

(54) MIXING SEGMENT, STATIC MIXER, DISPENSING ASSEMBLY AND METHOD OF MIXING MULTI-COMPONENT MATERIAL

(71) Applicant: Sulzer Mixpac AG, Haag (CH)

(72) Inventors: Mathias HACK, Winterthur (CH); Joachim SCHOECK, Winterthur (CH)

(21) Appl. No.: 16/758,188

(22) PCT Filed: Oct. 26, 2018
(86) PCT No.: PCT/EP2018/079443

§ 371 Date: Apr. 22, 2020

(30) Foreign Application Priority Data
Oct. 27, 2017 (EP) 17198846.2

(51) Int. Cl. B01F 5/06; B01F 13/00

(52) U.S. Cl. CPC B01F 5/064; B01F 13/0023; B01F 2215/0027; B01F 2215/0039; B01F 2215/006; B01F 5/0652

(57) ABSTRACT

A mixing segment for a static mixer includes inlets and outlets connected by a passage to deflect respective part flows of a material from the inlet to the outlet. Each of the outlets arranged such that an extent thereof is rotated by an angle of rotation of at least 45°. A first extent of the passages gradually reduces between an inlet and a constriction of the passage, and a second extent of the passage gradually increases between the constriction and the outlet. The reduction in size of the first extent or the increase in size of the second extent is formed by two walls of the passage that are inclined with respect to one another and with respect to the longitudinal axis of the mixing segment, with at least a part of the walls inclined with respect to the longitudinal axis formed by a curved part surface.

### CROSS-REFERENCE TO RELATED APPLICATION

This application is a U.S. National Stage application of International Application No. PCT/EP2018/079443, filed Oct. 26, 2018, which claims priority to European Patent Application No. 17198846.2, filed Oct. 27, 2017, the contents of each of which are hereby incorporated herein by reference.

### BACKGROUND

### Field of the Invention

The present invention relates to a mixing segment of a static mixer, the static mixer comprising a plurality of mixing segments for mixing a multi-component material. The invention further relates to a static mixer comprising a plurality of mixing segments, to a dispensing assembly comprising a static mixer and a multi-component cartridge filled with respective materials, as well as to a method of mixing multi-component material using a dispensing assembly.

### Background Information

Conventional static mixers respectively mixing tips, as they are also known as, can be used to mix multi-component material dispensed from a multi-component cartridge. Such static mixers are used in a plethora of fields of application ranging from industrial applications, such as the use of adhesives to bond structural components one to another, or as protective coatings for buildings or vehicles, to medical and dental applications, for example, to make dental molds.

The multi-component material is, for example, a two-component adhesive comprising a filler material and a hardener. In order to obtain the best possible mixing result, e.g. an adhesive having the desired bond strength, the multi-component material has to be thoroughly mixed.

For this purpose the static mixers comprise several mixing segments arranged one after the other that repeatedly divide and re-combine part flows of the multi-component material to thoroughly mix the multi-component material.

### SUMMARY

On mixing the multi-component material, the material remaining in the static mixer after the dispensing process is generally discarded as it remains in the static mixer. Depending on the field of application the multi-component material can be comparatively expensive and may only be used for one application at a time. This is particularly true, for example in the dental field, where only part of the multi-component material stored in the cartridge is used for one application/patient at a time with the remaining multi-component material being stored in the multi-component cartridge for future applications. Thus, the excessive use of large volumes of multi-component material remaining in a static mixer after a single use leads to unnecessary cost. Examples of prior art mixers are disclosed in U.S. Pat Nos. 3,406,947A and 3,195,865A.

For this reason it is an object of the present invention to provide a static mixer that guides respective part flows of the multi-component material efficiently through individual mixing segments for a thorough mixing of the multi-component material, that enables a reduction in the amount of mixing material left behind in a static mixer and that can be produced in an as facile manner as possible.

This object is satisfied by a mixing segment having the features described herein.

Such a mixing segment is suitable for a static mixer comprising a plurality of mixing segments for mixing a multi-component material, with the mixing segment comprising: at least three elongate inlets arranged at least substantially in parallel to one another; and at least three elongate outlets arranged at least substantially in parallel to one another; with a respective elongate inlet being connected to a respective elongate outlet via a respective passage to deflect respective part flows of the multi-component material from the elongate inlet to the elongate outlet;

wherein the elongate outlets are arranged such that an elongate extent thereof is rotated by an angle of rotation of at least 45°, preferably of at least substantially 90°, about a longitudinal axis of the mixing segment with respect to an elongate extent of the elongate inlets, with the longitudinal axis extending from the elongate inlets to the elongate outlets; wherein a first extent of the respective passage in a direction in parallel to the elongate extent of the elongate inlet gradually reduces in size between the elongate inlet and a constriction of the passage and a second extent of the respective passage in a direction in parallel to the elongate extent of the elongate outlet gradually increases in size between the constriction and the elongate outlet; and
wherein the gradual change in size of one of the first and second extents of the respective passage is formed by two walls of the respective passage that are inclined with respect to one another and with respect to the longitudinal axis of the mixing segment, with at least a part of the wall inclined with respect to the longitudinal axis being formed by a curved part surface, preferably with the curved part surface being present in the region of the constriction of at least some of the passages.

The use of at least three elongate inlets and elongate outlets provides a plurality of part flow paths along which the multi-component material can flow and be mixed. Increasing the number of flow paths within a mixing segment leads to an improvement of the mixing results achieved, since the respective part flows of the multi-component material are divided and re-combined more frequently into different part flow paths.

Thus, the mixing segments are generally designed in order to achieve the best possible mixing results while using as small a volume of the respective material of the multi-component material as possible in order to limit the waste of multi-component material.

It has hitherto been found that the shape of the mixing segments contributes to the quality of the mixing result and also to the volume of multi-component material left behind in the static mixer. By forming the mixing segments such that they comprise walls to guide the multi-component material to and from the constriction on dispensing, on the one hand, facilitates the mixing of the multi-component material and also reduces the space available within the mixing segment in which the multi-component material can be left behind after a dispensing process has taken place, such that less of a volume of multi-component material is required to achieve a thorough mixing of the multi-component material.

In this connection it should be noted that the mixing of material present in each flow path is further facilitated by compressing the size of the flow path in the first extent towards the constriction and by the subsequent increase in size of the flow path in the second extent by a rotation about the angle of rotation. In this way the part flow is not only forced to compress and relax in one direction of flow only, but is guided in a plurality of directions of flow to further improve the mixing result.

It should further be noted that the two walls of the respective passage that are inclined with respect to one another taper towards one another between the elongate inlet and the constriction and thereby form the gradual change in size of the first extent of the respective passage.

Forming at least part of the respective inclined surfaces as a curved part surface improves the guiding function of these surfaces in a direction towards and subsequently away from the constriction. This is particularly the case if the curved part surface is present in the region of the constriction.

It is further possible to form at least a part of the inclined surface from a curved surface, with the curved surface optionally being formed by a plurality of curved part surfaces each having different radii of curvature and/or with the walls of the passages inclined with respect to one another and the longitudinal axis respectively comprising curved part surfaces having different radii of curvature.

It should further be noted that the two walls inclined with respect to one another are preferably arranged opposite one another to face one another at least partly.

Likewise it should be noted that the two walls of the respective passage that are inclined with respect to one another taper away from one another between the constriction and the elongate outlet and thereby form gradual change in size of the second extent of the respective passage.

Preferably the gradual change in size between the other one of the elongate inlet and the constriction and the constriction and the elongate outlet is formed by one wall of the respective passage that is inclined with respect to the longitudinal axis. In this way guiding means or elements are present at both sides of the constriction that direct the flow of multi-component material and reduce the dead space in a mixing segment so that as little volume as possible of the multi-component material remains in the static mixer after a dispensing process has taken place.

Advantageously the wall of the passage inclined with respect to the longitudinal axis comprises at least two gradients. Providing the wall of the passage inclined with respect to the longitudinal axis with at least two gradients facilitates the guiding of the flow of material in the mixing segment and hence improves the mixing result.

It is preferred if the walls of the passage inclined with respect to one another each comprise at least two gradients. In addition or as an alternative, the walls of the passage inclined with respect to one another and the longitudinal axis have different gradients. In this way the guiding of the flow of material in the mixing segment can be further improved leading to a further improvement of the mixing result.

Preferably each of the walls inclined with respect to the longitudinal axis comprises a curved part surface, in particular with each of the walls of the passage inclined with respect to the longitudinal axis comprising at least two curved part surfaces having different radii of curvature. Curved part surfaces, on the one hand, facilitate a guiding function of the walls of the passages and, on the other hand, are simple to manufacture in an injection molded process.

Advantageously, at least some of the curved part surfaces form part of a respective transition of one of the passages from the wall inclined with respect to the longitudinal axis to a surface of a wall that extends at least substantially in parallel to the longitudinal axis. Such transitions can hence be produced in a favorable manner and further facilitate the flow guiding properties of the mixing segment.

It is preferred if the mixing segment comprises a body accommodating at least some of the passages, wherein walls project from the body, with the walls projecting from the body forming at least a part of one of the elongate outlets and/or one of the elongate inlets of the mixing segment. Such shapes facilitate the manufacture of the mixing segments and hence further reduce their cost of manufacture.

In this connection it should further be noted that the walls projecting from the body preferably form at least part of the surfaces of the passages that extend at least substantially in parallel to the longitudinal axis.

In this connection it should be noted that the walls projecting from the body and forming at least part of the elongate outlets are arranged perpendicular to the walls projecting from the body that form at least part of the elongate inlets.

In an expedient design, the elongate inlets and/or the elongate outlets arranged at an outer side of the mixing segment comprise at least one cut-out. Such cut-outs are formed in order to simplify the molds used in the manufacture of the mixing segment. Simplified molds, on the one hand, lead to reduced costs of manufacture of the mold and, on the other hand, reduce the number of faulty mixing segments formed, as less filigree components are made.

In this connection it should be noted that the cut-out is present between the body and the walls projecting from the body.

Advantageously the mixing segment has three elongate inlets and three elongate outlets. According to a different preferred design the mixing segment has four elongate inlets and four elongate outlets. Using three respectively four elongate inlets and outlets ensures a thorough mixing of the multi-component material.

Preferably at least one inlet has three walls formed by the mixing segment, with one of the walls having a reduced wall thickness in comparison to one of the other walls of the same inlet. Reducing the thickness of a wall of the mixing segment facilitates the manufacture of the mixing segment leading to a further reduction in the cost of manufacture thereof.

It is preferred if the wall having the reduced wall thickness connects the two other walls of the inlet.

It should be noted that it is expedient if the elongate inlets and the elongate outlets are arranged transverse to the longitudinal axis. In this way a mixing of the multi-component material takes place generally along the direction of the longitudinal axis and the part flows of multi-component material are respectively expanded in the direction of the elongate outlet transverse to the longitudinal axis.

Advantageously walls of the passages separating the respective elongate inlets and/or elongate outlets at a side of the mixing segment have a convex shape in the direction of the longitudinal axis. Such walls are simple to manufacture in a mold of an injection molded tool and hence facilitates the manufacture of the mixing segments.

Preferably a transition between directly adjacent walls of the passages is formed by a recess. Such a recess can easily be produced by a mold for the mixing segments and hence facilitates the manufacture of the mixing segments and thus leads to a reduction of the cost of manufacture of such mixing segments.

It is preferred if at least some of the elongate inlets and of the elongate outlets are configured and arranged to deflect respective part flows of the multi-component material from an elongate inlet arranged at an inner region of the static mixer to an elongate outlet arranged at an outer region of the static mixer and from an elongate inlet arranged at the outer region of the static mixer to an elongate outlet arranged at an inner region of the static mixer.

Preferably each elongate inlet and/or each elongate outlet has an opening having an at least generally rectangular shape. This is a simple design option for the shape of the inlets and outlets, also other shapes of the inlets and outlets are feasible. It should be noted in this connection that an area of each inlet opening should be approximately the same size and that an area of each outlet opening should be approximately the same size such that a volume of multi-component material that passes through each flow path is approximately the same to ensure a uniform through mixing.

It should be noted that an imaginary sleeve enveloping the mixing segment can at least generally have the shape of a cuboid. Such shapes of mixing segments are comparatively simple to manufacture and enable a simple insertion into a correspondingly shaped housing of a static mixer on assembly of the static mixer.

It should further be noted that the mixing segment can be formed in an injection molding process from a plastic material. Injection molded processes enable the bulk manufacture of a plethora of mixing segments in a comparatively short period of time in a simple to reproduce manner. Generally speaking the mixing segments described herein can be formed from a plastic such as a thermoplastic or a thermosetting polymer e.g. in an injection molding process.

According to a further aspect the present invention relates to a static mixer, the static mixer comprising a plurality of mixing segments of which at least some are configured as a mixing segment discussed in the foregoing,

wherein the plurality of mixing segments are arranged in series one after another along a longitudinal axis of the static mixer;
wherein the elongate outlets of one mixing segment are arranged next to the elongate inlets of the next mixing segment of the series; preferably wherein the elongate inlets of at least some of the plurality of mixing segments are arranged substantially in parallel to one another.

In this connection it should be noted that the individual mixing segments of the series can be separate from one another, but preferably the individual mixing segments of the series are connected to one another and are especially integrally formed as one mixing element, for example in an injection molding process.

The advantages discussed in the foregoing in relation to the mixing segments likewise hold true for the static mixer in accordance with the invention.

According to a further aspect the present invention relates to a dispensing assembly, the dispensing assembly comprises a static mixer as described herein and a multi-component cartridge filled with respective materials.

The advantages discussed in the foregoing in relation to the mixing segments likewise hold true for the dispensing assembly in accordance with the invention.

The multi-component cartridge can thus be filled with materials selected from the group of members consisting of topical medications, medical fluids, wound care fluids, cosmetic and/or skin care preparations, dental fluids, veterinary fluids, adhesive fluids, disinfectant fluids, protective fluids, paints and combinations of the foregoing.

Such fluids and hence the dispensing assembly can therefore be expediently used in the treatment of target areas such as the nose (e.g. anti-histaminic creams etc.), ears, teeth (e.g. molds for implants or buccal applications (e.g. aphtas, gum treatment, mouth sores etc.), eyes (e.g. the precise deposition of drugs on eyelids (e.g. chalazion, infection, anti-inflammatory, antibiotics etc.), lips (e.g. herpes), mouth, skin (e.g. anti-fungal, dark spot, acne, warts, psoriasis, skin cancer treatment, tattoo removal drugs, wound healing, scar treatment, stain removal, anti-itch applications etc.), other dermatological applications (e.g. skin nails (for example anti-fungal applications, or strengthening formulas etc.) or cytological applications.

Alternatively the fluids and hence the dispensing assembly can also be used in an industrial sector, e.g. in the building industry, the automotive industry etc., for example, as adhesives, paints, and/or as protective coatings.

According to yet a further aspect the present invention relates to a method of mixing multi-component material using a dispensing assembly as described herein, the method comprises the steps of:

dispensing multi-component material from the multi-component cartridge;

guiding the multi-component material to the static mixer;

making available at least three respective part flows of multi-component material; and

guiding said at least three respective part flows of the multi-component material from a respective elongate inlet to a constriction and then from the constriction to an elongate outlet; with the respective part flow being compressed by the gradual decrease in size of the passage between the elongate inlet and the constriction and then being rotated and relaxed again by the gradual increase in size of the passage between the constriction and the elongate outlet, with the compression, rotation and relaxation of the part flows causing at least a partial mixing of the part flow.

### BRIEF DESCRIPTION OF THE DRAWINGS

The invention will be explained in more detail hereinafter with reference to the drawings.

FIG. 1 is a perspective view of a dispensing assembly;

FIG. 2 is a perspective view of a mixing element of a static mixer;

FIGS. 3A-3D are respective side views of the mixing element of FIG. 2;

FIG. 4 is a perspective view of a further mixing element;

FIGS. 5A-5D are respective side views of the mixing element of FIG. 4;

FIG. 6 is a perspective view of a further mixing element; and

FIG. 7 is a perspective view of a further mixing element.

### DETAILED DESCRIPTION OF THE EMBODIMENTS

In the following the same reference numerals will be used for parts having the same or equivalent function. Any statements made having regard to the direction of a component are made relative to the position shown in the drawing and can naturally vary in the actual position of application.

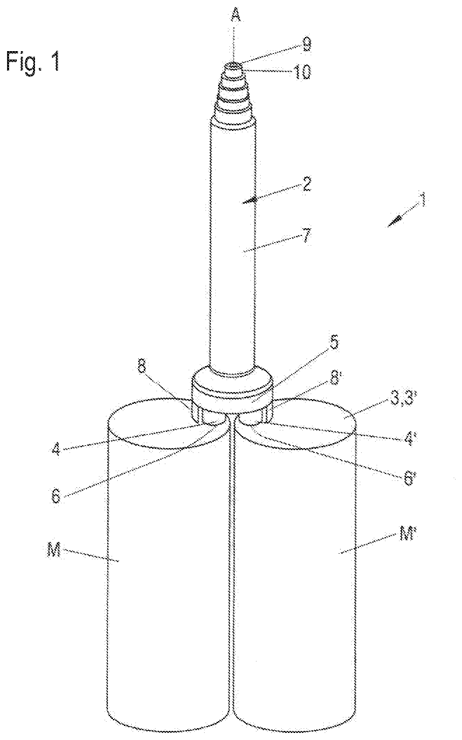

FIG. 1 schematically shows a dispensing assembly 1 comprising a static mixer 2 and a multi-component cartridge 3. The multi-component cartridge 3 shown in FIG. 1 is a two-component cartridge 3′ that is filled with respective two-component materials M, M′. For example, a hardener and a binder material.

The static mixer 2 comprises two inlets 4, 4′ at a first end 5 thereof. The two inlets 4, 4′ connect to outlets 6, 6′ of the two-component cartridge 3′. In the present example the inlets 4, 4′ receive the outlets 6, 6′ of the two-component cartridge 3′. It should be noted in this connection that other forms of interaction between the inlets 4, 4′ and the outlets 6, 6′ are possible.

A housing 7 of the schematically illustrated static mixer 2 further comprises alignment means or device 8, 8′ that enables a correct alignment of the inlets 4, 4′ of the static mixer 2 relative to the outlets 6, 6′ of the two-component cartridge 3′. The alignment device 8, 8′ can for example be configured as bayonet-like connection means or device (not shown) and hence also act as a kind of attachment means or device (not shown) to attach the static mixer 2 to the two-component cartridge 3′. Other kind of attachment means or devices (also not shown) such as a locking ring can also be used and are well known to the person skilled in the art.

The housing 7 further has a dispensing outlet 9 at a second end 10 of the static mixer 2. The mixed multi-component material M, M′ is dispensed via the dispensing outlet 9 following its passage through the static mixer 2. The dispensing outlet 9 is arranged at a longitudinal axis A of the static mixer 2. The longitudinal axis A extends from the inlets 4, 4′ of the static mixer 2 to the outlet 9 of the static mixer.

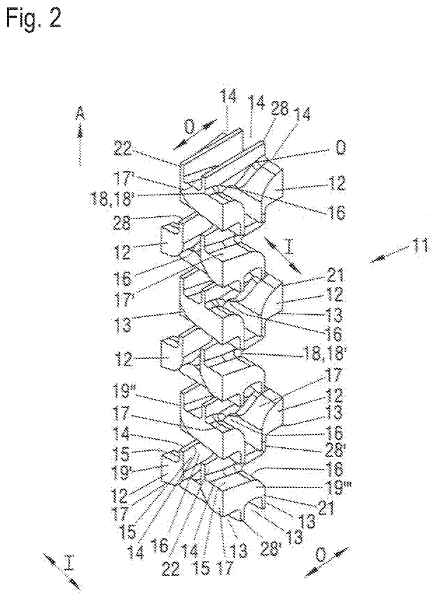

FIG. 2 shows a perspective view of a mixing element 11 of the static mixer 2. The mixing element 11 is composed of six mixing segments 12. The six mixing segments 12 are arranged in series one after another along the longitudinal axis A of the static mixer 2. Each mixing segment 12 comprises three elongate inlets 13 and three elongate outlets 14. The elongate outlets 14 of one mixing segment 12 are arranged next to the elongate inlets 13 of the next mixing segment 12 of the series.

In the present example each of the mixing segments 12 is of identical design. Each next mixing segment 12 of the series of mixing segments 12 is rotated by 180° about the longitudinal axis A relative to the directly adjacent mixing segment 12 of the mixing element 11. The rotation of each mixing segment 12 by 180° relative to the directly adjacent mixing segment 12 ensures an improved mixing of the multi-component materials M, M′ by way of a corresponding mixing element 11.

The elongate inlets 13 of the six mixing segments 12 are arranged substantially in parallel to one another. Likewise the elongate outlets 14 of the six mixing segments 12 are arranged substantially in parallel to one another.

A respective elongate inlet 13 of one mixing segment 12 is connected to a respective elongate outlet 14 of the same mixing segment 12 via a respective passage 15 to deflect respective part flows of the multi-component material from said elongate inlet 13 to said elongate outlet 14.

The elongate outlets 14 are arranged such that an elongate extent thereof is rotated by an angle of rotation of substantially 90° about the longitudinal axis A with respect to an elongate extent of the elongate inlets 13. In this connection it should be noted that the longitudinal axis A extends from the elongate inlets 13 to the elongate outlets 14.

A double headed arrow indicates a first extent I of the respective passage 15 in a direction in parallel to the elongate extent of the elongate inlet 13. The first extent I gradually reduces in size between the elongate inlet 13 and a constriction 16 of the passage 15. A second double headed arrow indicates a second extent O of the respective passage 15 in a direction in parallel to the elongate extent of the elongate outlet 14. The second extent O gradually increases in size between the constriction 16 and the elongate outlet 14.

In this connection it should be noted that the constriction 16 can be considered as a single point like transition between the first and second extents I, O in a plane extending in parallel to the elongate inlets 13 and elongate outlets 14 in which plane the first and second extents I, O have their respective smallest size.

Alternatively the constriction can be configured as an overlap region in which both the first extent I and the second extent O respectively change in size in order to reduce and expand the respective part flows of materials in the different directions corresponding to the elongate extents of the respective elongate inlets 13 and elongate outlets 14.

The gradual change in size of one of the first and second extents I, O of the respective passage 15 is formed by two walls 17 of the respective passage 15 that are inclined with respect to one another and with respect to the longitudinal axis A of the mixing segment 12. Moreover, the two walls 17 inclined with respect to one another are arranged opposite one another in order to directly face one another.

The gradual change in size between the other one of the elongate inlet 13 and the constriction 16 and the constriction 16 and the elongate outlet 14 is formed by one wall 17′ of the respective passage 15 that is inclined with respect to the longitudinal axis A.

When multi-component material M, M′ is guided in the respective passage 15, the material M, M′ present in each flow path is urged together between the respective elongate inlet 13 and the respective constriction 16 in the first extent I. Subsequently the material M, M′ present in each flow path is permitted to relax by the subsequent increase in size of the flow path in the direction of the second extent O. This constriction and expansion of the multi-component materials M, M′ takes place in different directions to improve the through mixing of the multi-component materials M, M′.

The first extent I and the second extent O are rotated by the same angle of rotation about the longitudinal axis A as is present between each respective elongate extent of the inlet 13 and elongate extent of the elongate outlet 14.

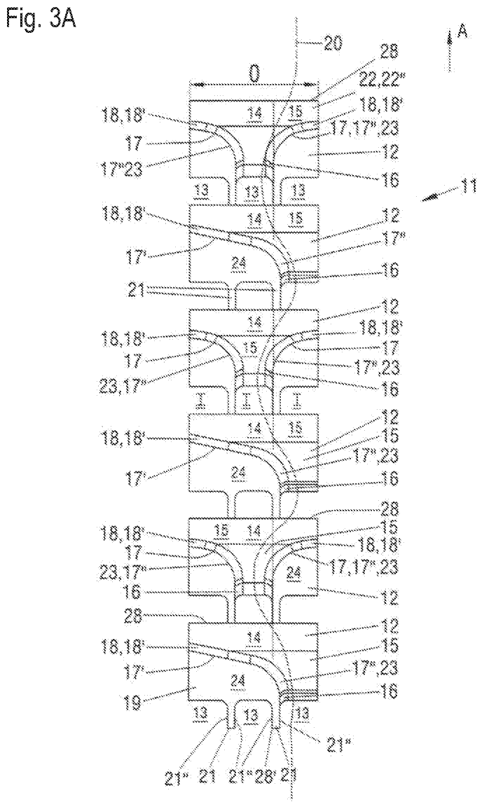

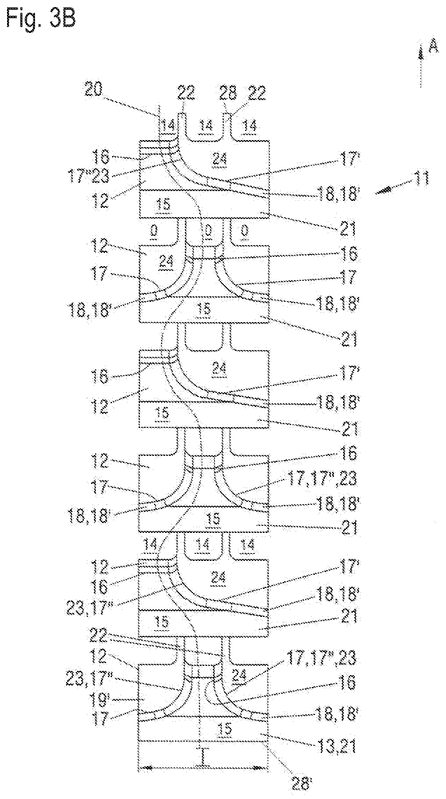

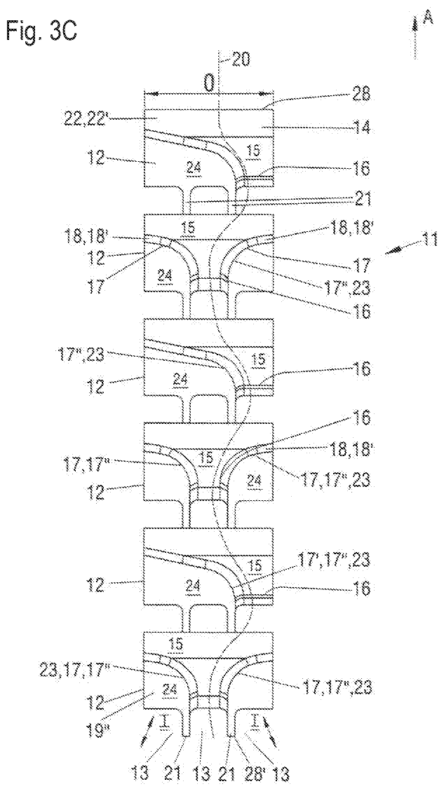

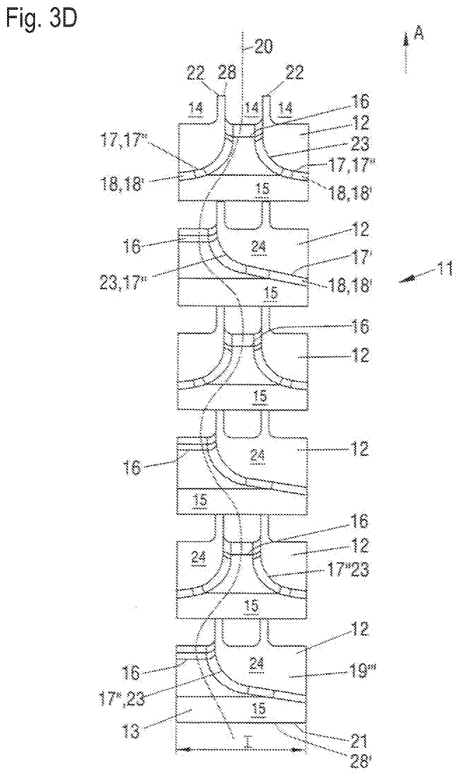

A transition 18 can further be seen in each passage which is present between walls 17, 17′ of the passages 15 directly adjacent to further walls 21, 22 (see also FIGS. 3A to 3D in this regard). The transition 18 can be formed by a curved surface 18′ as shown or as a recess (not shown). It has namely been found that the provision of a curved surface 18′ or a recess as a transition has beneficial effects on mixing and guiding the part flows of multi-component material M, M′ between the respective elongate inlets 13 and elongate outlets 14.

It should further be noted that an imaginary sleeve enveloping each mixing segment 12 at least generally has the shape of a cuboid. In this way each mixing segment 12 and hence the mixing element 11 has four sides 19, 19′, 19″, 19″′, as well as a top and a bottom side 28, 28′.

FIGS. 3A to 3D show respective views of the four sides 19, 19′, 19″, 19″′ of the mixing element 11 of FIG. 2. The walls 17, 17′ comprise curved part surfaces forming guide walls that are configured to direct the part flows of the multi-component material M, M′ from the respective elongate inlet 13 via the respective constriction 16 to the respective elongate outlet 14 of the respective mixing segment 12.

The changes in size of each passage 15 lead to a distribution of flow components being present in each part flow of the multi-component material M, M′ along the length of each of the six mixing segments 12 of the mixing element 11. One of these components is an outer flow component 20 (see FIGS. 3A to 3D) that comprises flow components flowing in a direction directed at least substantially in the direction of the longitudinal axis A of the static mixer 2.

In this connection it should be noted that the mixing segments 12, 12′, 12″, 12′″ shown in FIG. 2 and the following Figs. are generally rectangular cuboids in which the height to side length ratios of the sides 19, 19′, 19″, 19′″ can be selected in the range of 0.7 to 0.9, i.e. for a mixing segment of 8 mm width the height in the longitudinal direction A can be 6.4 mm.

FIGS. 3A to 3D respectively indicate the outer flow component 20 for each of the part flows present at an outer side 19, 19′, 19″, 19′″ of the mixing element 11 by a dashed line. The respective outer flow component 20 extends essentially along the inner wall of the housing 7 at the outer side 19, 19′, 19″, 19″′ of the mixing element 11 and is less likely to be subjected to the mixing than the flow components extending through passages 15 present within other parts of the mixing segment 12.

FIGS. 3A to 3D further show that the respective elongate inlets 13 of each mixing segment 12 are separated from one another by two walls 21. Likewise the respective elongate outlets 14 of each mixing segment 12 are separated from one another by two walls 22. The walls 21, 22 project from the body 24 of the mixing segment 12.

In this connection it should be noted that an outer boundary of each elongate inlet and elongate outlet present at an outer side 19, 19′, 19″, 19″′ of the mixing segment 12 is formed by an internal wall (not shown) of the housing 7 of the static mixer 2.

In this connection it should be noted that a mixing element 11, respectively a mixing segment 12 is preferred that has a quadratic basic shape in a cross-section perpendicular to the longitudinal axis A. Basic shapes having a rectangular, slightly curved, oval or round cross-section perpendicular to the longitudinal axis A are also possible.

It should further be noted that a thickness of each of the walls 21, 22 can be selected in the range of 0.12 to 1.5 mm, especially of 0.16 to 1.05 mm. In the examples shown in FIGS. 3A to 3D the walls 21, 22 have a thickness that corresponds to 0.52 mm.

It should further be noted that the walls 21, 22 have a height that projects from the body with said height being able to be selected in the range of 0.4 to 3 mm. In the examples shown in FIGS. 3A to 3D the walls 21, 22 have a height that corresponds to 0.8 mm.

In this connection it should be noted that each of the sides 19, 19′, 19″, 19″′ of the mixing segments 12 can have a width in the direction perpendicular to the longitudinal axis A selected in the range of 4 to 15 mm and in the example shown in FIGS. 3A3a to 3D have a width that corresponds to 8 mm.

Preferably a wall thickness of each of the walls 21, 22 is selected to be 3 to 10%, preferably of 4 to 7% of the width of the sides 19, 19′, 19″, 19″′.

In this connection it should be noted that each of the sides 19, 19′, 19″, 19″′ can have a height in the direction in parallel to the longitudinal axis A selected in the range of 4 to 15 mm and in the example shown in FIGS. 3A to 3D have a height that corresponds to 8 mm.

As indicated in FIGS. 3A to 3D the walls 17, 17′ forming the walls 17 inclined with respect to the longitudinal axis A respectively comprise a curved part surface 17″. The curved part surface 17″ extends towards the constriction 16 and hence is present in the region of the constriction 16.

In this connection it should be noted that the radii of curvature of the curved part surface 17″ can generally be selected in the range of 0.2 to 0.3 times the width of the mixing segment 12, i.e. for an 8 mm wide mixing segment 12 the radii is selected in the range of 1.6 to 2.4 mm and in the examples of FIGS. 3A to 3D have a radius of curvature corresponding to at least approximately 2 mm.

It is further possible that the curved part surface 17″ is formed by a plurality of curved part surfaces 17″ each having different radii of curvature. In this event, the curved part surface 17″ having the largest radius of curvature is that curved part surface 17″ that is present within the respective constriction 16 and forms a transition 23 from the inclined wall 17 to a surface 21′, 22′ that extends at least substantially in parallel to the longitudinal axis A. The surfaces 21′, 22′ form part of one of walls 21, 22 of the respective elongate inlets and outlets 13, 14.

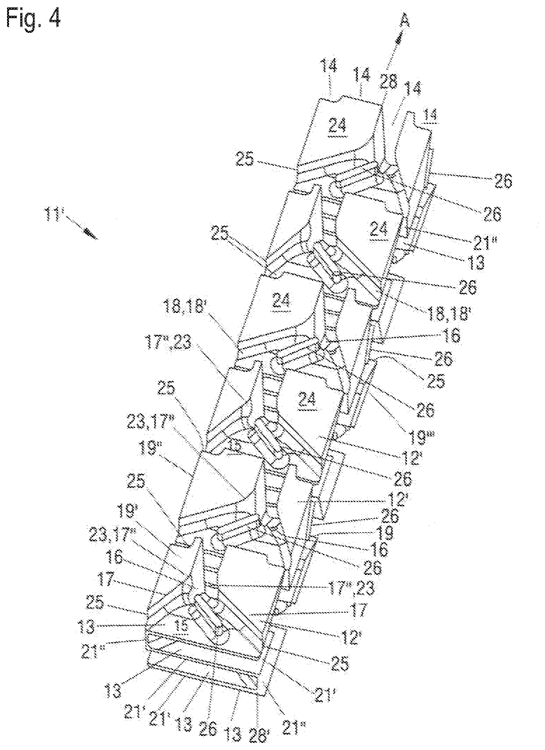

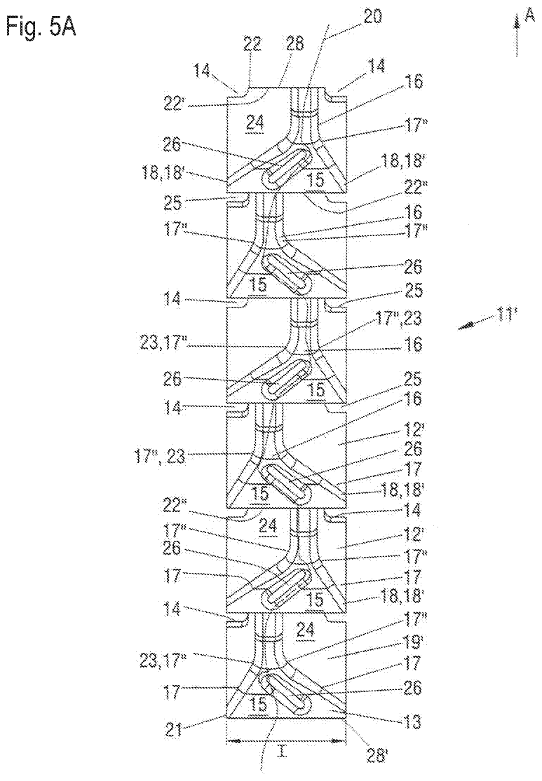

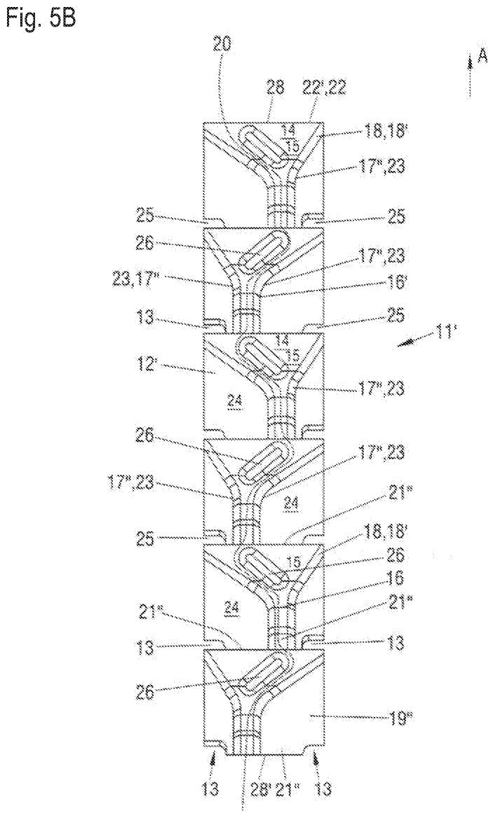

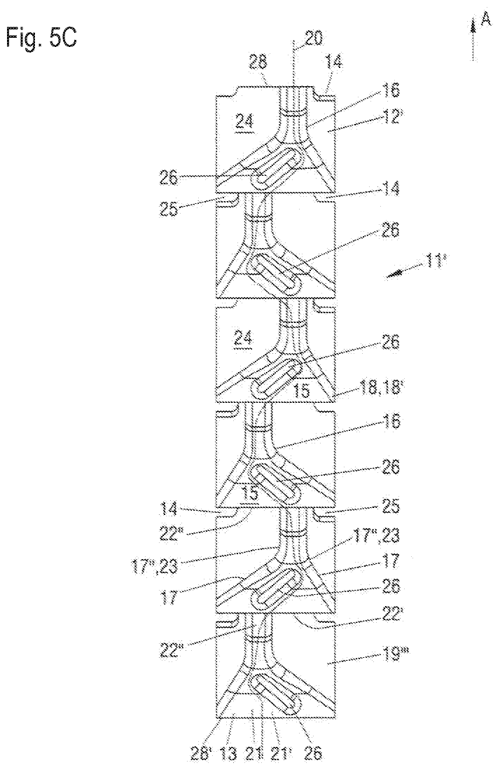

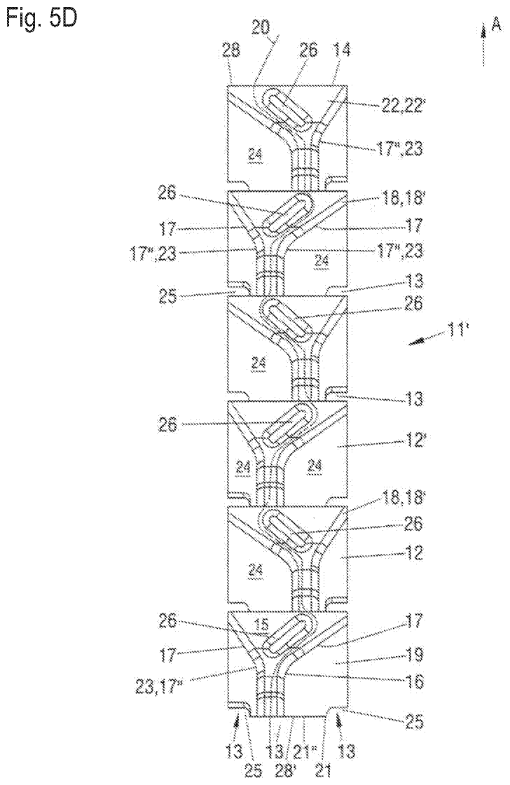

It should be noted in this connection that the walls 17, 17′ of the respective passage 15 inclined with respect to the longitudinal axis A can comprise at least two gradients if formed by respective straight part surfaces, as for example indicated in FIGS. 4 to 5D.

In this connection it should be noted that each of the gradients is selected in the range of 0.176 to 0.577, especially of 0.2 to 0.4. In this connection it should be noted that the gradient of the straight part surface of the wall 17 is defined as the change in height in the longitudinal direction A divided by the change in width of the respective side 19, 19′, 19″, 19″′ of the respective wall 17 and consequently is a dimensionless number.

The walls 21, 22 forming at least a part of one of the elongate outlets 14 and/or one of the elongate inlets 13 of the mixing segment 12 respectively project from a body 24 of the mixing segment 12. The walls 22 projecting from the body 24 and forming at least part of the elongate outlets 14 are arranged perpendicular to the walls 21 projecting from the body 24 that form at least part of the elongate inlets 13.

The embodiment shown in FIG. 4 shows a further type of mixing element 11′ of the static mixer 2 that is formed by six mixing segments 12′. Each of the six mixing segments 12′ has four elongate inlets 13 and four elongate outlets 14. Like in the example of the mixing element 11 shown in FIGS. 2 to 3D, the mixing segments 12′ are designed to include a plurality of flow paths for the mixing of the multi-component material M, M′.

In the present example two types of mixing segments 12′ are provided that each have a very similar design. Every second mixing segment 12′ is a second type of mixing segment 12′ that differs from the first type of mixing segment 12′. The difference being that the respective elongate inlet 13 present at the outer side 19 of the first mixing segment 12′ leads to the left hand inner elongate outlet 14 and the elongate inlet 13 present at the outer side 19″ leads to the right hand inner elongate inlet 14 of the mixing segment 12′. With regard to the second mixing segment 12′ of the series the respective elongate inlet 13 present at the outer side 19 of the first mixing segment 12′ leads to the right hand inner elongate outlet 14 and the elongate inlet 13 present at the outer side 19″ leads to the left hand inner elongate inlet 14 of the mixing segment 12′.

In this connection the difference between the configuration and arrangement of the first and second types of mixing segments 12′ of the mixing element 11′ is that the elongate outlets 14 of each second type of mixing segment 12′ are rotated by 180° relative to the elongate outlets 14 of the first type of mixing segment 12′ and the respective second type of mixing segment 12′ is then mirror imaged at a plane comprising the longitudinal axis A and the normal thereto extending from the side 19 of the drawing of FIG. 4.

Some of the walls 21, 22 respectively projecting from the body 24 of the mixing segment 12 are connected to one another via a further wall 21″, 22″ at an outer side 19, 19′, 19″, 19′″ of the mixing segments. In this way some of the elongate inlets and outlets have three walls 21, 21″, 22, 22″ extending from the body 24. The further wall 21″, 22″ bridging the walls 21, 22 forming the respective planar surface 21′, 22′ each have a reduced wall thickness in comparison to the other walls 21, 22 of the same elongate inlet or outlet 13, 14. The walls 21″, 22″ bridging the walls 21, 22 are a part of the respective passage 15.

A cut-out 25 is respectively present in the region of the elongate inlets and outlets 13, 14 arranged at each of the outer sides 19, 19′, 19″, 19′″ of the mixing segment 12′. The cut-out 25 is respectively provided in order to simplify a mold (not shown) that is used during the injection molding process used to manufacture the respective mixing elements 11, 11′, 11″, 11″′.

In this connection it should be noted that the cut-out 25 is present between the bodies 24 of directly adjacent mixing segments and the walls 21, 22 projecting from said bodies 24.

As discussed in the foregoing, the changes in size present in each of the passages 15 lead to a distribution of flow components being present in the part flow of the multi-component material M, M′.

One of these components is the outer flow component 20 that flows at least substantially in the direction of the longitudinal axis A of the static mixer 2. In order to prevent small fractions of unmixed multi-component material M, M′ from flowing between the inlets 4, 4′ and the outlet 9 and consequently being dispensed, the respective passages 15 comprise a deflector plate 26 arranged in the flow path either in the region of the elongate inlet 13 or in the region of the elongate outlet 14.

The deflector plate 26 is configured to deflect at least some of said outer flow component 20 of the part flow of the multi-component material M, M′ in the region of the elongate inlet 13 or in the region of the elongate outlet 14 away from the direction of flow directed at least substantially in the direction of the longitudinal axis A in order to further improve the mixing results.

The deflector plate 26 is namely arranged within the respective passage 15 in order to ensure that each part flow of the multi-component material M, M′ arrives at a respective elongate outlet 14 at approximately the same time, at approximately the same speed and with approximately the same surface area. Due to the varying geometries present within the respective passage 15 of the mixing segment 12 each part flow comprises flow components that flow faster than others. The deflector plates 26 are configured and arranged to slow down the faster flow components such that they have approximately the same flow speed as the slower flow components in such a way that each respective part flow present in the respective passage 15 has a leading edge that extends at least approximately over the complete extent of the elongate outlet 14 and in parallel to the elongate outlet 14.

It should be noted that the deflector plates 26 are arranged at the outer sides 19, 19′, 19″, 19′″ of the mixing segments 12. As is visible from the views shown in FIGS. 5A to 5D each mixing segment 12 of the mixing element 11′ two deflector plates 26 in the region of its elongate inlets 13 and two-deflector plates 26 in the region of its elongate outlets 14.

If a deflector plate 26 is provided, then the deflector plates 26 is generally arranged such that at least one end thereof is arranged such that it is in axial alignment with a center of the constriction 16 arranged closest thereto.

In the embodiment shown both ends of the deflector plate 26 are arranged such that they are in axial alignment with the center of the respective constriction 16 to which they are arranged closest.

The walls 17 inclined with respect to the longitudinal axis A extend from the outer sides 19, 19′, 19″, 19′″ towards the longitudinal axis A as straight part surfaces until they reach the transition 23 formed by a curved part surface 17″ that then leads to the planar surfaces 21′, 22′ formed by the respective walls 21, 22.

FIGS. 5A to 5D show views similar to the ones depicted in FIGS. 3A to 3D of the mixing element 11′ shown in FIG. 4. As can be seen in the different views each passage 15 of the mixing segments 12′ comprises two inclined walls 17 that lead to the transition 23 towards the walls 21, 22 forming the planar surfaces 21′, 22′ present in the region of the elongate inlets and outlets 13, 14.

In this connection it should be noted that, in dependence on the wall 17, the radii of curvature depicted in the examples of FIGS. 5A to 5D correspond to 1.6 mm and to 2.4 mm respectively, i.e. each side 19, 19′, 19″, 19′″ comprises one wall 17 having a curved part surface with a radius of 1.6 mm and one wall 17 having a curved part surface with a radius of 2.4 mm.

In this connection it should be noted that for a four way mixing segment 12′ each of the inclined walls 17 of each side 19, 19′, 19″, 19′″ have different gradients a first gradient of the first inclined wall 17 of each side 19, 19′, 19″, 19″′ can be selected in the range of 1.19 to 1.73 and a second gradient of the second inclined wall of each side 19, 19′, 19″, 19″′ can be selected in the range of 0.58 to 0.83. In the examples of FIGS. 5A to 5D the first gradient corresponds to 1.43 and the second gradient corresponds to 0.7.

It should further be noted that the thickness of each of the walls 21, 22 in the examples shown in FIGS. 5A to 5D the walls have a thickness that corresponds to 0.52 mm.

In this connection it should be noted that each of the sides 19, 19′, 19″, 19″′ of the mixing segments 12 in the examples shown in FIGS. 5A to 5D have a width that corresponds to 8 mm.

In this connection it should be noted that each of the sides 19, 19′, 19″, 19′″ in the examples shown in FIGS. 5A to 5D have a height that corresponds to 8 mm.

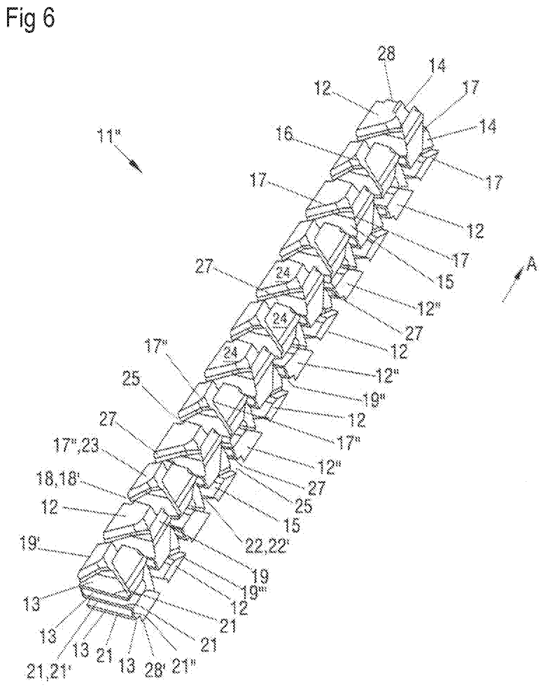

FIG. 6 shows a perspective view of a further mixing element 11″ that can be inserted into the housing 7 of the static mixer 2. The mixing element 11″ comprises mixing segments 12 having four elongate inlets 13 and four elongate outlets 14 that do not comprise any deflector plates similar to the mixing segments 12 shown in accordance with the design shown in FIGS. 2 to 3D. The mixing element 11″ further has mixing segments 12″ that also comprise four elongate inlets 13 and four elongate outlets 14 as well as at least one blocking element 27. In contrast to the design of the mixing segments 12′ illustrated in FIGS. 4 to 5D, no deflector plates 26 are present at the mixing segments 12, 12″.

The respective blocking element 27 is arranged and configured to block off at least part of the respective passage 15 so that at least some of said outer flow component 20 of the part flow of the multi-component material M, M′ in the region of the elongate inlet 13 or in the region of the elongate outlet 14 is directed away from the direction of flow directed at least substantially in the direction of the longitudinal axis A at the four sides 19, 19′, 19″, 19′″ of the mixing element 11″′ in order to further improve the mixing results achievable therewith.

In this way the blocking element 27 takes over a similar function as that of the deflector plates 26 illustrated in connection with FIGS. 4 to 5D, namely to deflect flow away from the direction of flow directed at least substantially in the direction of the longitudinal axis A, by intermittently slowing down the outer flow component 20 and thereby aiding in ensuring that each part flow of the multi-component material M, M′ arrives at a respective elongate outlet 14 at approximately the same time and such that the respective part flow has a leading edge that extends approximately over the complete extent of the elongate outlet 14 and in parallel to the elongate outlet 14.

Thus, the at least one blocking element 27 is arranged at an outer side 19, 19′, 19″, 19″′ of the respective mixing segment 12″ in the region of the elongate inlet 13 or outlet 14 in order to direct a part of the outer flow component 20 of the multi-component material M, M′ away from entering one of the directly adjacent elongate inlets 13.

Some designs are possible that comprise two or more blocking elements 27 at one mixing segment 12″. In this case the two block elements 27 are preferably arranged at opposite sides 19, 19″, 19′, 19″′ of the mixing segment 12.

Since the at least one blocking element 27 is arranged at a position within one of the flow paths for the multi-component material M, M′ such that it blocks a flow path present along a main direction of flow of the respective part flow of multi-component material M, M′, the at least one blocking element 27 is arranged at one of the plurality of mixing segments 12″ that is not the first and/or the last mixing segment of the series of mixing segments 12, 12″ forming the mixing element 11″.

As is further visible in the view of the mixing element 11″, the walls 21, 22 of the passages 15 separating the respective elongate inlets 13 and/or elongate outlets 14 at a side of the mixing segment 12, 12″ have a convex shape in the direction of the longitudinal axis A. Such convex shapes enable a more simple tool to be used for the injection mold and hence facilitate the manufacture of the mixing segments 12, 12″ respectively of the corresponding mixing element 11″.

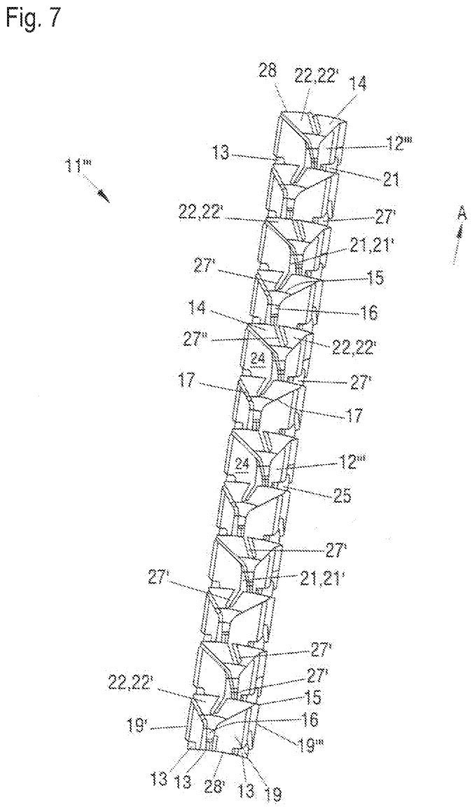

FIG. 7 shows a perspective view of a further mixing element 11′″ that can be inserted into the housing 7 of the static mixer 2. In the design depicted in FIG. 7 each mixing segment 12″′ has four elongate inlets and four elongate outlets. The respective deflector plate 26′ is arranged to extend from one of the walls 21, 22 of the respective passage 15 of the directly adjacent mixing segment 12′″. This is achieved by integrally forming the deflector plate 26′ with said wall 21, 22 of the passage 15.

In all of the embodiments shown the elongate inlets 13 and the elongate outlets 14 are arranged transverse to the longitudinal axis A.

It should further be noted that in accordance with all of the depicted embodiments, that, at least some of (FIGS. 2 to 3D), preferably all of (FIGS. 4 to 7) the elongate inlets 13 and of the elongate outlets 14 are configured and arranged to deflect respective part flows of the multi-component material M, M′ from an elongate inlet 13 arranged at an inner region of the mixing element 11 of the static mixer 2 to an elongate outlet 14 arranged at an outer region of the mixing element 11 of the static mixer 2 and from an elongate inlet 13 arranged at the outer region of the mixing element 11 of the static mixer 2 to an elongate outlet 14 arranged at an inner region of the mixing element 11 of the static mixer 2.

It should further be noted that each elongate inlet 13 and each elongate outlet 14 shown in the foregoing has an opening having an at least generally rectangular shape.

It is preferred if the respective mixing segments are formed in an injection molding process from a plastic material. Regardless of the method of manufacture of the mixing element 11, 11′, 11″, 11′″ respectively of the mixing segments 12, 12′, 12″, 12″′ the only space available within each of the mixing segments 12, 12′, 12″, 12′″ is part of a respective flow path for the multi-component material M, M′ introduced into the static mixer 2 from the multi-component cartridge 3, 3′ discussed in the foregoing.

In this way the volume of the multi-component materials M, M′ remaining in the static mixer 2 after a dispensing process has taken place can be minimized as the dead space within the static mixers 2 are minimized in comparison to those available in the prior art. Moreover, the specific designs of the mixing segments 12, 12′, 12″, 12″′ have been chosen to bring about an optimized mixing of the multi-component materials M, M′.

In this connection it should be noted that the various mixing segments 12, 12′, 12″, 12″′ discussed in the foregoing to form the presented mixing elements 11, 11′, 11″, 11′″ can also be mixed to form a mixing element (not shown) comprising a mixture of the various mixing segments 12, 12′, 12″, 12′″ discussed and shown in the present application.

The mixing element 11, 11′, 11″, 11″′ may also comprise other forms of mixing segments differing in design in addition to the ones shown in the present application. For example, wave like mixing segments, round mixing segments, rectangular mixing segments, mixing segments of static mixers sold under the trade name T-mixer or Quadro-mixer by Sulzer Mixpac can be used in combination with the mixing segments 12, 12′, 12″, 12″′ discussed in the foregoing to form the mixing element 11, 11′, 11″, 11″′.

1. A mixing segment for a static mixer, the mixing segment being on of a plurality of mixing segments in a static mixer for mixing a multi-component material, the mixing segment comprising:
at least three elongate inlets arranged at least substantially in parallel to one another; and
at least three elongate outlets arranged at least substantially in parallel to one another,
a respective elongate inlet of the at least three elongate inlets being connected to a respective elongate outlet of the at least three elongate outlets via a respective passage to deflect respective part flows of the multi-component material from the elongate inlet to the elongate outlet;
each of the elongate outlets arranged such that an elongate extent thereof is rotated by an angle of rotation of at least 45° about a longitudinal axis of the mixing segment with respect to an elongate extent of the respective elongate inlet, with the longitudinal axis extending from the elongate inlets to the elongate outlets
a first extent of each of the respective passages in a direction parallel to the elongate extent of the respective elongate inlet gradually reduces in size between the respective elongate inlet and a constriction of the respective passage, and a second extent of the respective passage in a direction parallel to the elongate extent of the respective elongate outlet gradually increases in size between the constriction and the respective elongate outlet, and
one of the reduction in size of one of the first extent and the increase in size of the second extent is formed by two walls of the respective passage that are inclined with respect to one another and with respect to the longitudinal axis of the mixing segment, with at least a part of the walls inclined with respect to the longitudinal axis formed by a curved part surface.

2. The mixing segment in accordance with claim 1, wherein each of the elongate outlets is arranged such that the elongate extent thereof is rotated by an angle of rotation of at least substantially 90° about a longitudinal axis of the mixing segment with respect to the elongate extent of the respective elongate inlet.

3. The mixing segment in accordance with claim 1, wherein the curved part surface is present in the region of the constriction of at least some of the respective passages.

4. The mixing segment in accordance with claim 1, wherein the reduction in size between an other one of the elongate inlet and the constriction and the constriction and the elongate outlet is formed by one wall of the respective passage that is inclined with respect to the longitudinal axis.

5. The mixing segment in accordance with claim 1, wherein the walls inclined with respect to the longitudinal axis comprise at least two gradients or the walls inclined with respect to one another and the longitudinal axis have different gradients.

6. The mixing segment in accordance with claim 4, wherein each of the two walls and the one wall inclined with respect to the longitudinal axis comprises a curved part surface.

7. The mixing segment in accordance with claim 6, wherein each of the two walls and the one wall is inclined with respect to the longitudinal axis comprises at least two curved part surfaces having different radii of curvature.

8. The mixing segment in accordance with claim 1, wherein the walls inclined with respect to one another and the longitudinal axis comprise curved part surfaces having different radii of curvature.

9. The mixing segment in accordance with claim 1, wherein at least some of the curved part surfaces form part of a respective transition of the respective passages from the two wall inclined with respect to the longitudinal axis to a surface of another wall that extends at least substantially in parallel to the longitudinal axis.

10. The mixing segment in accordance with claim 1 further comprising a body accommodating at least some of the respective passages, and the another wall projects from the body, with the another wall forming at least a part of an elongate outlet of the elongate outlets or an elongate inlet of the elongate inlets.

11. The mixing segment in accordance with claim 1, wherein the elongate inlets or the elongate outlets are arranged at an outer side of the mixing segment and comprise at least one cut-out.

12. The mixing segment in accordance with claim 1, wherein at least one elongate inlet of the elongate inlet or at least one elongate outlet of the elongate outlets has three walls formed by the mixing segment, with one of the three walls having a reduced wall thickness in comparison to one of the other three.

13. The mixing segment in accordance with claim 12, wherein the wall of the three walls having the reduced wall thickness connects the two other walls of the three walls of the elongate inlet or elongate outlet.

14. The mixing segment in accordance with claim 1, wherein the elongate inlets and the elongate outlets are arranged transverse to the longitudinal axis.

15. The mixing segment in accordance with claim 1, wherein walls of the respective passages at a side of the mixing segment have a convex shape in the a direction of the longitudinal axis.

16. The mixing segment in accordance with claim 1, wherein a transition between directly adjacent walls of the respective passages is formed by a curved surface or a recess.

17. The mixing segment in accordance with claim 1, wherein the at least three elongate inlets includes only three elongate inlets and the at least three elongate outlets includes only three elongate outlets, or wherein the mixing segment the at least three elongate inlets includes four elongate inlets and the at least three elongate outlets includes four elongate outlets.

18. The mixing segment in accordance with claim 1, wherein at least some of the elongate inlets and of the elongate outlets are configured and arranged such that part flows of the multi-component material are deflected from a first elongate inlet of the elongate inlets arranged at an inner region of the static mixer to a first elongate outlet of the elongate outlets arranged at an outer region of the static mixer and from a second elongate inlet of the elongate inlets arranged at the outer region of the static mixer to a second elongate outlet of the elongate outlets arranged at the inner region of the static mixer.

19. The mixing segment in accordance with claim 1, wherein each elongate inlet or elongate outlet has an opening having an at least generally rectangular shape.

20. The mixing segment in accordance with claim 1, wherein an imaginary sleeve enveloping the mixing segment at least generally has the shape of a cuboid.

21. The mixing segment in accordance with claim 1, wherein the mixing segment is formed in an injection molding process from a plastic material.

22. A static mixer comprising:
the plurality of mixing segments including the mixing segment in accordance with claim 1,
wherein the plurality of mixing segments arranged in series one after another along a longitudinal axis of the static mixer,
the elongate outlets of the mixing segment the mixing segment are arranged adjacent to the elongate inlets of the next mixing segment disposed adjacent the mixing segment.

23. The static mixer in accordance with claim 22, wherein the elongate inlets of at least some of the plurality of mixing segments are arranged substantially in parallel to one another.

24. A dispensing assembly comprising:
the static mixer in accordance with claim 22; and
a multi-component cartridge filled with materials.

25. A method of mixing multi-component material using the dispensing assembly in accordance with claim 24, the method comprising:
dispensing multi-component material from the multi-component cartridge;
guiding the multi-component material to the static mixer;
making available at least three respective part flows of multi-component material; and
guiding the at least three respective part flows of the multi-component material from a respective elongate inlet of the elongate inlets to the constriction and then from the constriction to a respective elongate outlet of the elongate outlets, the respective part flow being compressed by the gradual decrease in size of the respective passage between the elongate inlet and the constriction and then being rotated and relaxed again by the gradual increase in size of the respective passage between the constriction and the elongate outlet, with the compression, rotation and relaxation of the respective part flows causing at least a partial mixing of the respective part flow.
